(19) United States
(12) Patent Application Publication
(10) Pub. No.: US 2010/0294148 A1
(43) Pub. Date: Nov. 25, 2010

(54) PRINTING MODULE AND PRINTING MACHINE PROVIDED WITH SUCH A PRINTING MODULE

(75) Inventors: Adrianus Henricus Ignatius Maria VERKUIJLEN, Didam (NL); Hendrikus Theodorus Gerardus Wientjens, Leuth (NL)

Correspondence Address: BIRCH STEWART KOLASCH & BIRCH, PO BOX 747, FALLS CHURCH, VA, 22040-0747, US

(73) Assignee: MPS Holding B.V., Didam (NL)

(21) Appl. No.: 12/785,210

(22) Filed: May 21, 2010

(30) Foreign Application Priority Data
May 22, 2009 (NL) 2002915

(51) Int. Cl. B41L 13/04

(52) U.S. Cl. 101/116

(57) ABSTRACT

Printing module provided with an impression roller, a rotary screen cylinder which is provided with a print image, which rotary screen cylinder in use abuts, with interposition of a substrate (S) to be printed, against the impression cylinder, wherein the printing module further comprises a driving shaft for driving the rotary screen cylinder, which driving shaft is provided substantially parallel to the rotary screen cylinder at a side thereof remote from the impression cylinder, and a bearing assembly, which bearing assembly is positioned adjacent the impression cylinder at a side thereof, in use, facing the driving shaft, wherein a distance between the driving shaft and the bearing assembly is adjustable such that the rotary screen cylinder is bearing mountable between the driving shaft and the bearing assembly.

The invention relates to a printing module provided with an impression roller, a rotary screen cylinder which is provided with a print image, which rotary screen cylinder in use abuts, with interposition of a substrate to be printed, against the impression cylinder.

Such a printing module is known from practice. This known printing module involves an impression cylinder rotatably arranged in a printing module frame. The printing module further comprises a rotary screen cylinder positioned adjacent the impression cylinder. In use, the rotary screen cylinder is driven by a drive arranged in the printing module. A substrate to be printed is displaced between said rotary screen cylinder and the impression cylinder to transfer the image of the rotary screen to the substrate. The rotary screen cylinder is rotatably bearing mounted between the impression cylinder and two additional bearing rollers. The additional bearing rollers are movably arranged in the frame of the printing module and are provided on a side of the rotary screen cylinder facing away from the impression cylinder. The bearing rollers are arranged to move along a predetermined path from a remote location with respect to the rotary screen cylinder to a location wherein the bearing rollers engage the screen cylinder. In this engaging position, the bearing rollers and the impression cylinder, or at least a bearing element of the impression cylinder, enclose an outer surface of the screen cylinder such that in use, the screen cylinder is bearing mounted rotatable with respect to the printing module frame. In case a change of repeat length of the image to be printed is necessary, the bearing rollers are removed from the outer surface of the rotary screen cylinder and displaced along the predetermined path towards the remote location. The rotary screen cylinder with the first repeat length can be removed and replaced by a rotary screen cylinder with a second repeat length. The newly inserted screen cylinder has to be operably connected to the drive. The bearing rollers are displaced along the predetermined path from the remote location towards the outer surface of the rotary screen cylinder such that the screen cylinder with the different repeat length is enclosed by the bearing rollers and the impression cylinder. In order to properly enclose different rotary screen cylinders with different diameters for printing images with different repeat lengths, the predetermined paths, that are adapted to guide the respective bearing rollers, have a curved shape. This curved shape enables the bearing rollers to enclose the respective rotary screen cylinder such that an angle between the respective bearing rollers and the impression cylinder is substantially equal to the angle between said respective bearing rollers and the impression cylinder when enclosing a different rotary screen cylinder. Thus, every rotary screen cylinder that is used in the printing module is bearing mounted at, at least three points substantially evenly distributed along the outer circumferential surface of said rotary screen cylinder. Consequently, the known printing module has a relatively complex construction. Furthermore, the displacement of the respective bearing rollers has to be arranged in a precise manner to ensure that the rotary screen cylinder is bearing mounted properly in order to achieve a high quality printed image.

It is therefore an object of the invention to provide a printing module according to the above described type, wherein the advantages of the known printing module are maintained and the disadvantages of the known printing module are at least partly overcome. More in particular, it is an object of the invention to provide a printing module with a simplified structure to properly bearing mount the rotary screen cylinder in the printing module in a simple manner.

Thereto, according to a first aspect of the invention, the above described printing module is characterized in that the printing module further comprises a driving shaft for driving the rotary screen cylinder, which driving shaft is provided substantially parallel to the rotary screen cylinder at a side thereof remote from the impression cylinder, and a bearing assembly, which bearing assembly is positioned adjacent the impression cylinder at a side thereof, in use, facing the driving shaft, wherein a distance between the driving shaft and the bearing assembly is adjustable such that the rotary screen cylinder is rotatably bearing mountable between the driving shaft and the bearing assembly. Such a construction of the printing module enables that only one part of the printing module, thus the bearing assembly or the driving cylinder has to be displaced with a substantially linear movement to be able to insert the rotary screen cylinder in the printing module and to subsequently enclose the outer surface of the rotary screen cylinder to bearing mount the cylinder in the printing module. Furthermore, the impression cylinder is not needed to provide the bearing mounted position of the rotary screen cylinder. Setting of the rotary screen cylinder relative to the impression cylinder may become simpler. Since the driving shaft is use rotates the rotary screen cylinder, the impression cylinder can be non-driven. The impression cylinder may be rotated due to the rotation of the rotary screen cylinder. Not only is costly setting time, and hence loss of production time saved in this way, but inserting and changing rotary screen cylinder is rendered simpler. As a consequence inserting and changing cylinders is achieved much faster.

To be able bearing mount the rotary screen cylinders properly between the driving shaft and the bearing assembly, the bearing assembly may, according to a further aspect of the invention, comprise at least one pair of at least two bearing rollers positioned at mutual distance to receive at least a part an outer circumferential surface of the rotary screen cylinder. Preferably, the respective bearing rollers are arranged stationary with respect to a bearing frame of the bearing assembly. This further enhances a simple construction of the printing module.

According to a further aspect of the invention, the respective central axes of the driving shaft, the rotary screen cylinder and the impression cylinder, respectively, preferably extend substantially in a same cylinder plane, for instance in a substantially horizontal plane.

The driving shaft may, according to a further aspect of the invention, be movably connected with respect to a frame of the printing module, preferably in a substantially horizontal direction. According to a further aspect of the invention, the bearing assembly and/or the impression cylinder may be movably connected with respect to the frame of the printing module. Adjusting the distance between the bearing assembly and the driving shaft may be easily obtained by displacement of at least one of the bearing assembly and the driving shaft in a direction substantially parallel to the direction of the cylinder plane. With such a construction of the printing module, the displacement may be a linear displacement. To provide said linear displacement the printing module does not need a complex construction for providing the relative displacement.

Consequently, with the aid of said construction of the printing module, changing of the rotary screen cylinder with a first diameter for a rotary screen cylinder with a different diameter in the printing module can be easily arranged. In order to be able to provide rotary screen cylinders with different diameters in the printing module and to be able to bearing mount each screen cylinder properly, the bearing assembly may, according to a further aspect, comprise a plurality of bearing rollers, arranged in pairs, wherein the respective bearing rollers of each pair are arranged at mutual distance, wherein the distance between the bearing rollers of the pair most remote from the impression cylinder is larger than the distance between the bearing rollers of the pair most near to the impression roller, wherein respective central axes of the bearing rollers of each pair extend in a plane that is arranged substantially perpendicular with respect to the cylinder plane. Preferably, the distance between the bearing rollers of each pair is adapted to receive a cooperating rotary screen cylinder with a cooperating diameter for printing an image with a certain repeat length such that said rotary screen cylinder is enclosed by the respective pair of bearing rollers and the driving shaft.

It is advantageous if, according to a further aspect of the invention, the or each pair of bearing rollers is located with respect to the impression cylinder such that an outer circumferential surface of the rotary screen cylinder in the bearing mounted position abuts against an outer circumferential surface of the impression cylinder. By providing such an arrangement of the pairs of bearing rollers in the bearing assembly, the position of the impression cylinder does not have to be set anew upon inserting a rotary screen cylinder with a certain diameter. Thus, changing of the screen cylinder may be accomplished in a short period of time thereby preventing the printing module from being out of operation for too long.

In order to drive the rotary screen cylinder, the rotary screen cylinder may comprise at least one transmission element, preferably arranged adjacent an end of the rotary screen cylinder. Furthermore, the driving shaft may also comprise at least one transmission element, such as a gear wheel, that in use cooperates with the transmission element of the rotary screen cylinder to rotatably drive the rotary screen cylinder. The driving shaft may in turn be driven by a drive arranged in the printing module. Upon changing of the rotary screen cylinder, the driving shaft is brought into engagement with said rotary screen cylinder to bearing mount the cylinder. At the same time, the transmission elements engage such that the rotary screen cylinder is operably connected to the drive of the printing module.

In further elaboration of the invention, the driving shaft may be removably received in a receiving section of a cylinder receiving unit provided in the printing module. Preferably, cylinder receiving unit may be adapted to receive a plate cylinder of another printing technology such as a flexographic plate cylinder or an offset plate cylinder. The printing module can be easily adapted by removing the rotary screen cylinder, removing the driving shaft and inserting a plate cylinder into the cylinder receiving unit. After displacing the receiving unit towards the impression cylinder and providing a suitable ink system, the printing module is ready for use with a different printing technology. It may be advantageous if the printing module for rotary screen printing further comprises an ink system movably arranged with respect to a frame of the printing module. By already providing an ink system in the printing module, changing from rotary screen technology to another printing technology such as flexographic printing technology may be even easier. Preferably, the ink system is arranged at a side of the cylinder receiving unit facing away from the impression cylinder. When the printing module is adapted to rotary screen printing, the ink system is not used. When necessary, the ink system only needs to be displaced to be able to operably position it with respect to the plate cylinder.

The invention also relates to a printing apparatus provided with the abovementioned printing module. Such a printing apparatus provides similar effects and advantages as described above with the printing module. Further aspects of the printing module and the printing apparatus provided with such a printing module are set forth in the dependent claims.

The invention will now be further elucidated by means of, non-limiting, examples referring to the drawing, in which

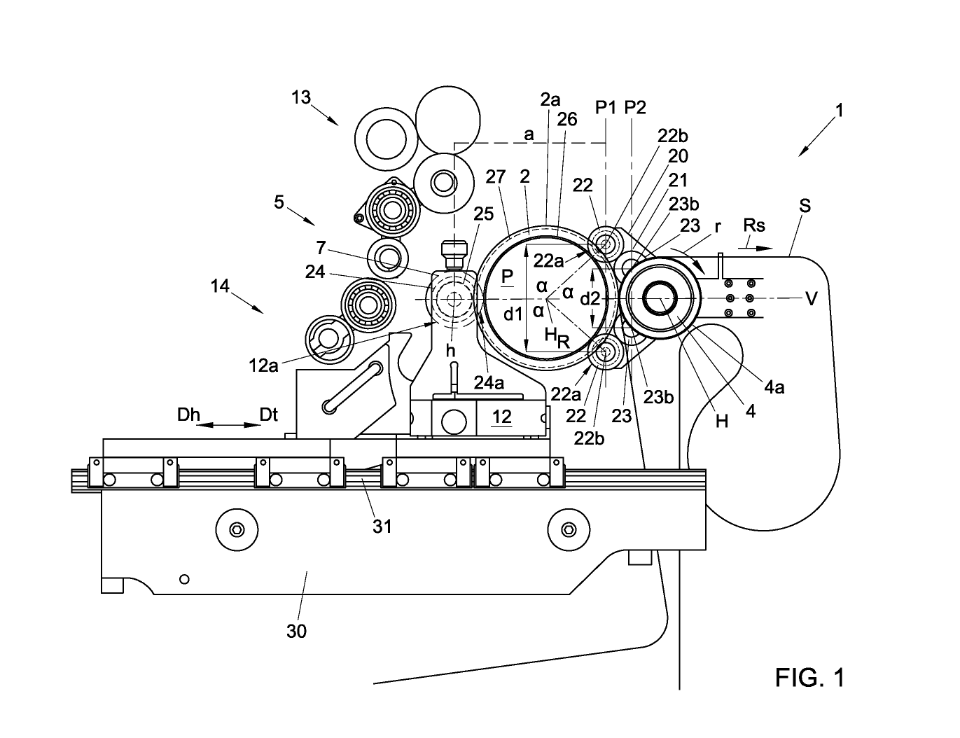

FIG. 1 schematically shows a side view of an embodiment of the printing module according to the invention;

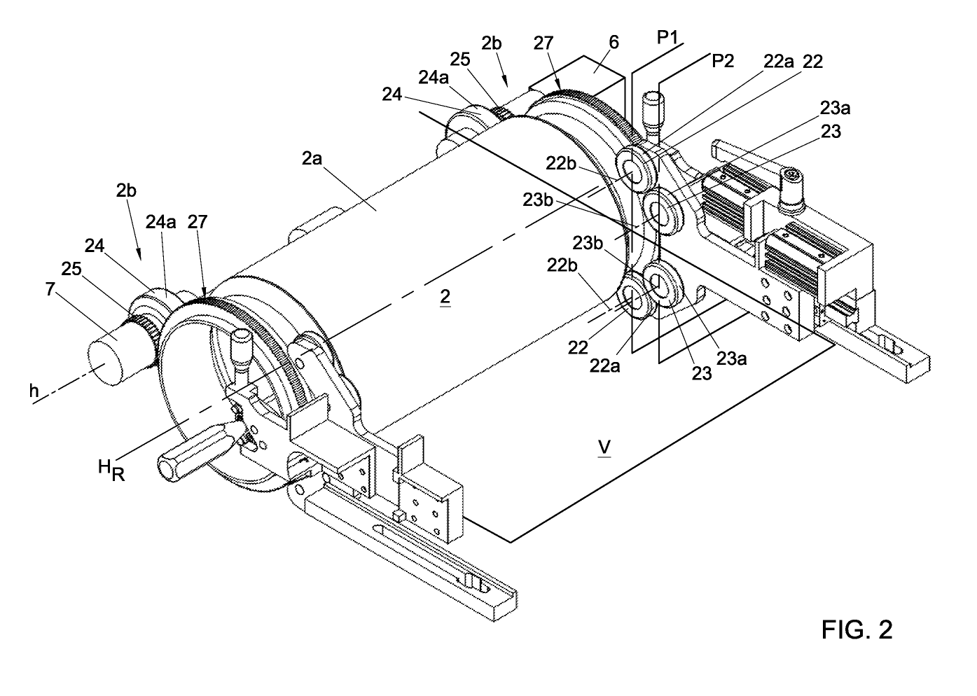

FIG. 2 schematically shows a perspective view of the embodiment of FIG. 1;

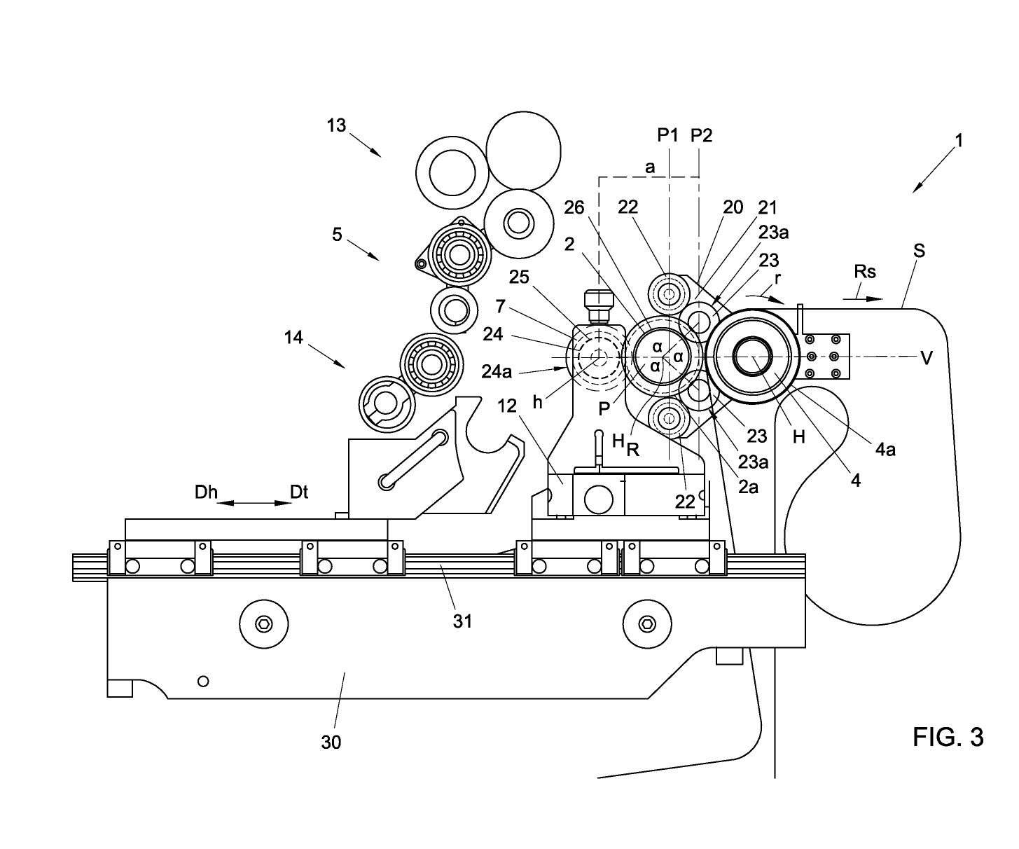

FIG. 3 schematically shows a side view of the embodiment of the printing module according to the invention as shown in FIG. 1 comprising a rotary screen cylinder with a different repeat length;

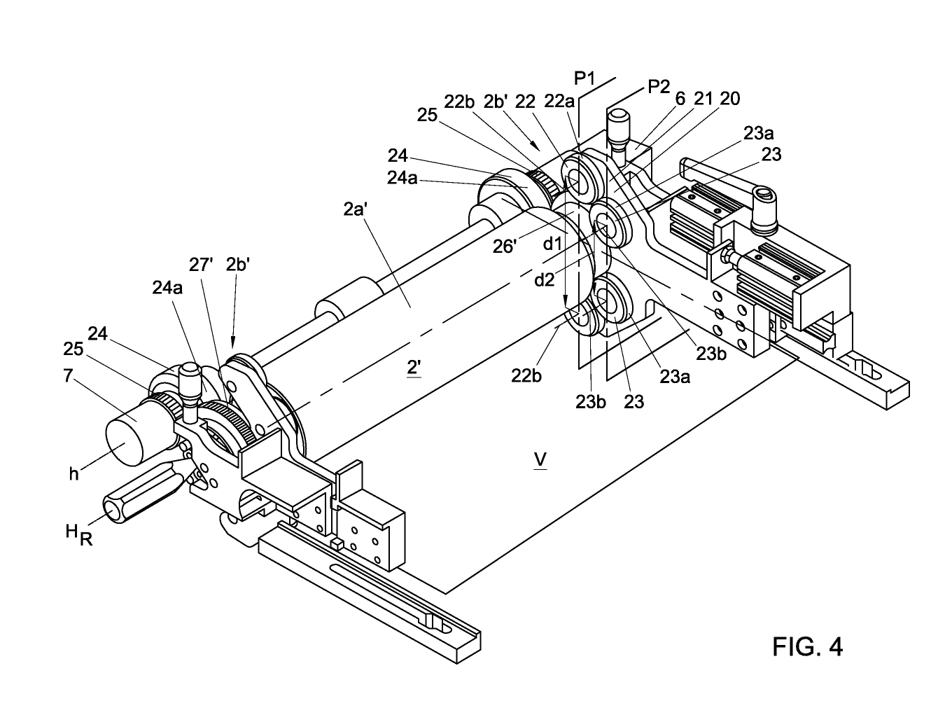

FIG. 4 schematically shows a perspective view of the embodiment of FIG. 1; and

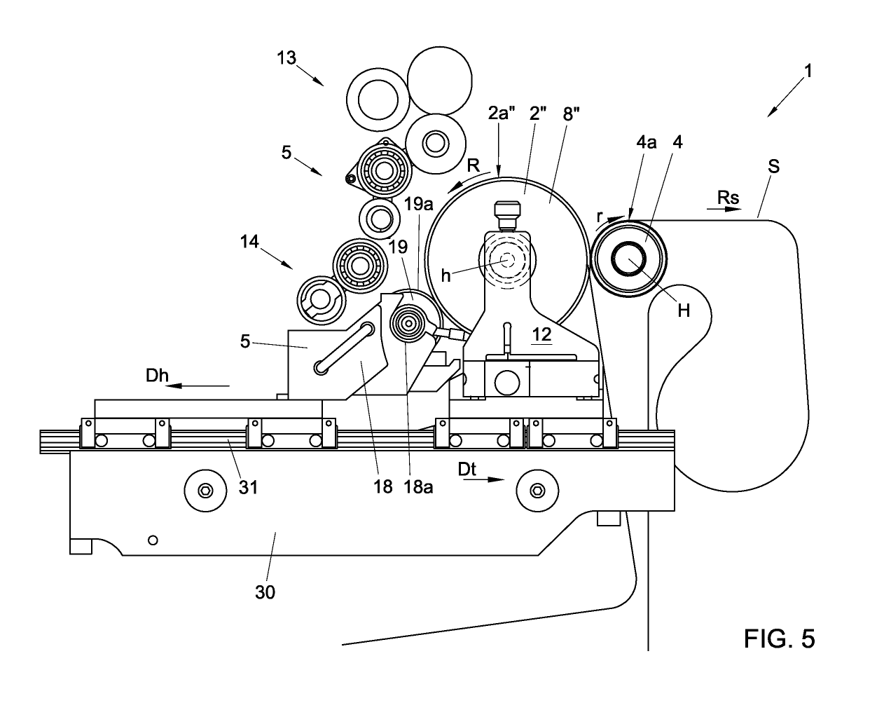

FIG. 5 schematically shows a side view of the embodiment of the printing module according to the invention adapted for another printing technology.

It is noted that identical or corresponding elements in the different drawings are indicated with identical or corresponding reference numerals.

FIG. 1 shows a printing module 1 according to an exemplary embodiment of the invention. The printing module 1 is adapted for rotary screen printing technology. The printing module 1 comprises a frame 30 with guiding rails 31 provided thereon extending in a substantially horizontal direction Dh, Dt. The guiding rails 31 are adapted to movably receive separate units of the printing module 1, as for instance the cylinder receiving unit 12. The printing module 1 further comprises an impression cylinder 4 that is rotatably arranged in the frame 30 of the module 1. The impression cylinder 4 has a substantially flexible outer surface, for instance of a rubber. Adjacent the impression cylinder 4, a bearing assembly 20 is arranged for rotatably receiving the rotary screen cylinder 2. The distance a between the bearing assembly 20 and the driving shaft 7 is adjustable to receive rotary screen cylinders of different sizes. In this example, the rotary screen cylinder is a 24-inch cylinder. The bearing assembly 20 is positioned between the impression cylinder 4 and the cylinder receiving unit 12. The cylinder receiving unit 12 comprises a cylinder receiving section 12a in which a driving shaft 7 for driving the rotary screen cylinder 2 is provided. The driving shaft 7 is positioned parallel to the rotary screen cylinder 2. The driving shaft 7 is drivable by a drive 6 (see for instance FIG. 2). The bearing assembly 20 comprises a bearing frame 21 that in this example of the invention is arranged stationary with respect to the impression cylinder 4. On the bearing frame 20, two pairs of bearing rollers 22, 23 are provided arranged such that, in use, a central axis HR of the rotary screen cylinder 2 extends in a plane V that extends through the central axis H of the impression cylinder 4 as well as through the central axis h of the driving shaft 7. In this example of the printing module 1 according to the invention, the plane V preferably extends substantially parallel to the guiding elements 31 of the frame 30 of the printing module 1.

A first pair of bearing elements 22 is arranged with respect to the bearing frame 21 to receive a circumferential outer edge 26 of the rotary screen cylinder 2 such that the circumferential outer surface 2a of the rotary screen cylinder 2 in use, with interposition of the substrate S, abuts with the circumferential outer surface 4a of the impression cylinder 4. Consequently, the image of the rotary screen cylinder 2 can be transferred to the substrate S. In the shown example of the printing module 1, the circumferential outer edge 26 is set back with respect to the circumferential outer surface 2a. Due to the set back position, the rotary screen cylinder 2 is secured against movement in an axial direction thereof. Preferably, the distance dl between the respective bearing rollers 22 of the first pair is such that an angle a between the respective bearing rollers and between the respective bearing rollers 22 and the driving shaft 7 is approximately 90-135° when enclosing the rotary screen cylinder 2 of that specific diameter. Consequently, the bearing points are substantially evenly distributed along the outer circumferential surface 2a of the rotary screen cylinder 2, thereby providing a proper bearing mounted position. The central axes 22b of both bearing rollers 22 extend in a plane P1 that is arranged substantially perpendicular with respect to the cylinder plane V. A second pair of bearing elements 23 is arranged with respect to the bearing frame 21 to receive a circumferential outer edge 26′ of the rotary screen cylinder 2′ of a smaller diameter as will be described with reference to FIGS. 3 and 4 later on. The bearing surfaces 23a of the second pair of bearing rollers 23 do not contact with the outer circumferential surface 2a of the rotary screen cylinder 2 when using the 24-inch rotary screen cylinder 2. As will be clear, the rotary screen cylinder 2 is bearing mounted at both ends 2b. Consequently, two bearing frames 20 may be provided in the printing module 1 to bearing mount both ends 2b of the screen cylinder 2.

Referring also to FIG. 2, the rotary screen cylinder 2 comprises two transmission elements 27 that are arranged adjacent opposite ends 2b of the rotary screen cylinder 2. In the shown embodiment of the rotary screen cylinder 2, the transmission elements 27 comprise a gear wheel. The gear wheels 27 are adapted to cooperate with transmission elements 25 that are arranged on the drive shaft 7. The drive shaft 7 further comprises two bearing elements 24 that enclose the rotary screen cylinder 2 on a side opposite the bearing assembly 20 such that the rotary screen cylinder 2 is bearing mounted rotatably arranged in the frame 30 of the printing module 1. The bearing elements 24 contact the circumferential edge 26 of the rotary screen cylinder 2 with the bearing surfaces 24a thereof. By providing the bearing assembly 20 with two bearing rollers 22 for a certain rotary screen cylinder 2 at a stationary position with respect to the impression cylinder 4, the position of the impression cylinder 4 does not have to be set anew. By also providing a movable driving shaft 7 that drives the rotary screen cylinder 2 and at the same time is adapted to enclose the rotary screen cylinder 2 at a third bearing point, a flexible printing module 1 is obtained. The printing module 1 has a simple construction and can be adapted easily.

In order to adjust the printing module 1 for rotary screen printing with a smaller repeat length, the 24-inch cylinder may be replaced by a 12-inch cylinder. Therefore, the cylinder receiving unit 12 (see FIGS. 1 and 3) is displaced along the guiding rails 31 in the horizontal and linear direction Dh such that the bearing mounted connection of the rotary screen cylinder 2 is removed. Due to the displacement, between the driving shaft 7 and the rotary screen cylinder 4 a space is provided. This space allows easy access to the rotary screen cylinder 2. The rotary screen cylinder 2 may be removed from the printing module 1. Another rotary screen cylinder 2′ having a 12-inch size may subsequently be provided between the bearing assembly 20 and the cylinder receiving unit 12.

FIGS. 3 and 4 show a schematically side view and perspective view of the embodiment of the printing module 1 according to the invention comprising the 12-inch rotary screen cylinder 2′. For the sake of clarity, only the elements that differ from the printing module 1 as shown and described with FIG. 1 will be described here in detail. To insert the rotary screen cylinder 2′ in the printing module 1, both ends 2b′ thereof are positioned adjacent the bearing assembly 20. The second pair of bearing rollers 23 is adapted to cooperate with the outer circumferential edges 26 of the screen cylinder 2′. In use, the outer circumferential edge 26 rotates in an opposite direction with respect to the circumferential surface 23a of the bearing roller 23. The driving shaft 7, that is received in the cylinder receiving unit 12, is moved in the horizontal direction Dt along the guiding rails 31 until at least part of the outer circumferential surfaces 24a of the bearing elements 24 of the driving shaft 7 abut with the outer circumferential surface 2a′, more in particular with the outer circumferential edge 26′, of the rotary screen cylinder 2′. The rotary screen cylinder 2′ is bearing mounted between the bearing rollers 23 and the driving shaft 7. Thus, by only displacing the necessary elements of the printing module 1 in a linear direction, adjustment of the printing module 1 is possible. In another embodiment of the printing module 1 according to the invention, it is possible that the bearing assembly 20 and/or the impression cylinder 4 are movable with respect to the frame 30 to provide the bearing mounted position of the rotary screen cylinder 2′. The impression cylinder 4 may also be movably arranged with respect to the bearing assembly 20 order to be able to use an impression cylinder with a different diameter or to enable easy setting or removal of the impression cylinder 4.

Preferably, the distance d2 between the respective bearing rollers 23 of the second pair is such that an angle a between the respective bearing rollers 23 and the driving shaft 7 is approximately 90-135° when enclosing the rotary screen cylinder 2′. The central axes 22b of both bearing rollers 22 extend in a plane P2 that is arranged substantially perpendicular with respect to the cylinder plane V and arranged substantially parallel with respect to the plane P1 of the first pair of bearing rollers 22. When using the 12-inch rotary screen cylinder 2′, the first pair of bearing rollers 22 is not used. To drive the rotary screen cylinder 2′, the transmission elements 25 engage with the transmission elements 27′ provided at the opposite ends 2b′ of the screen cylinder 2′. Preferably, the driving shaft 7 is removably received in the receiving section 12a of the cylinder receiving unit 12. Because of the simple construction of the printing module 1, the printing module may be easily adjusted to another printing technology than screen printing technology.

FIG. 5 shows the printing module 1 according to the invention adapted for flexographic printing technology. To adjust the printing module 1 to be used for flexographic printing technology, the rotary screen cylinder 2, 2′ is removed from the printing module 1, after displacement of the driving shaft 7 in the horizontal direction Dh. Subsequently, the driving shaft 7 is removed from the receiving section 12a of the cylinder receiving unit 12. The impression cylinder 4 remains in its position. A plate cylinder, in this case a flexographic plate cylinder 2″ is inserted in the receiving section 12a of the cylinder receiving unit 12. In another embodiment of the invention, the flexographic plate cylinder 2″ may instead comprise a core and a flexographic plate cylinder sleeve. In this case, when changing the repeat length of the flexographic plate cylinder, only the sleeve has to be changed for a sleeve of another diameter instead of changing the entire flexographic plate cylinder 2″.

The printing module 1 is also provided with an ink system 5 that is movably arranged along the guiding rails 31. The ink system 5 comprises a flexographic ink provision 18 comprising a receiving opening 18a for receiving an anilox roller 19. In the ink provision 18, an ink receptacle (not shown) and an ink roller (not shown) are provided. In use, ink from the ink receptacle is applied to the anilox roller 19 by means of the ink roller. Subsequently, the anilox roller 19 applies said ink to the outer circumferential surface 2a″ of the flexographic plate roller 2″. In another embodiment of the invention, the ink system 5 may already be available in the printing module 1 when it is adapted for rotary screen technology. However, in the latter case, the ink system 5 is positioned at a distance from the driving shaft 7 in order to not obstruct the rotary screen printing process (see for instance FIGS. 1 and 3). After insertion of the flexographic plate cylinder 2″, the cylinder receiving unit 12 is displaced in the horizontal direction Dt until the flexographic plate cylinder 2″ abuts, with interposition of the substrate S to be printed, against the impression cylinder 4. The ink system 5 is displaced along the horizontal direction Dt until the anilox roller 19 is positioned adjacent the flexo plate cylinder 2″ such that the outer circumferential surface 19a of the anilox roller 19 cooperates with the outer circumferential surface 2a″ of the flexographic plate cylinder 2″ to apply ink to provide the flexographic plate cylinder 2″ with a film of ink to transfer the image of the flexographic plate cylinder 2″ to the substrate S. In the shown embodiment the ink system 5 further comprises a moisturising system 13 and an ink provision 14 that are adapted to be used in case the printing module 1 is used for offset printing technology. However, in another embodiment of the invention, the printing module 1 adapted for rotary screen printing technology may only comprise an ink system 5 adapted for flexographic printing technology or the printing module 1 may only comprise a provision for receiving the ink system 5 in case the printing module is converted from rotary screen printing technology into flexographic printing technology. This ink system 5 will be removed from the printing module 1 again in case the printing module 1 is converted from flexographic printing technology into rotary screen printing technology.

Both, the printing module 1 adapted for rotary screen printing technology and the printing module 1 adapted for flexographic printing technology use the same impression cylinder 4. In use, upon driving the plate cylinder 2″, the impression cylinder 4 rotates in the same direction r as during rotary screen printing. The direction of displacement Rs of the substrate S also stays the same. Thus, the printing module 1 according to the invention has a construction that enables easy adjustment of the repeat length of the screen cylinder 2, 2′ as well as easy change of printing technology. The printing module 1 may be used in a printing apparatus, for instance a label printing apparatus, comprising at least one further printing module adapted for a different printing technology, such flexographic printing or offset printing or for a different label technology, such as perforation technology, punching technology, foil lamination technology, metal effect printing and the like.

In the foregoing specification, the invention has been described with reference to specific examples of embodiments of the invention. It will, however, be evident that various modifications and changes may be made therein without departing from the broader spirit and scope of the invention as set forth in the appended claims. For instance, the rotary screen cylinder may comprise only one transmission element at one end of the screen cylinder. Furthermore, the bearing assembly may comprise more than two pairs of bearing elements to receive more than two different rotary screen cylinders. The respective bearing elements may be arranged at different positions with respect to the bearing frame, for instance dependent on the size of the rotary screen cylinders to be used in the printing module 1. Furthermore, the bearing frame 21 may be of a different construction and may be mounted to the printing module frame 30 in a different way. The rotary screen cylinder 2, 2′ may have a different construction and be of different materials. Also the bearing rollers 22, 23 and the bearing elements 24 may be of different materials. Instead of arranging the central axes of the respective cylinders and shaft in a plane substantially parallel to the horizontal direction, said plane may also extend in a slight angle, for instance of approximately 10 degrees, with respect to the horizontal direction. The cylinder receiving unit 12 may have a different construction and may be movable with respect to the bearing assembly in a different way. Furthermore, the driving shaft 7 may have a different shape and construction. Also the rotary screen cylinder may be driven in a different way by the driving shaft. The different elements, such as the cylinder receiving unit 12 may be movable mounted in the frame 30 of the printing module 30 in a different way, as long as the distance between the bearing assembly 20 and the driving shaft 7 may be adjusted in an easy manner, preferably by a simple linear movement. The impression cylinder may in another embodiment of the invention have a substantially solid outer circumferential surface, for instance of steel, and the outer circumferential surface of the plate cylinder may be adapted such that is cooperates with said solid outer circumferential surface of the impression cylinder.

However, other modifications, variations and alternatives are also possible. The specifications, drawings and examples are, accordingly, to be regarded in an illustrative rather than in a restrictive sense.

In the claims, any reference signs placed between parentheses shall not be construed as limiting the claim. The word ‘comprising’ does not exclude the presence of other features or steps then those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to advantage.

1-15. (canceled)

16. Printing module provided with an impression roller, a rotary screen cylinder which is provided with a print image, which rotary screen cylinder in use abuts, with interposition of a substrate (S) to be printed, against the impression cylinder,
characterized in that the printing module further comprises a driving shaft for driving the rotary screen cylinder, which driving shaft is provided substantially parallel to the rotary screen cylinder at a side thereof remote from the impression cylinder, and a bearing assembly, which bearing assembly is positioned adjacent the impression cylinder at a side thereof, in use, facing the driving shaft, wherein a distance between the driving shaft and the bearing assembly is adjustable such that the rotary screen cylinder is rotatably bearing mountable between the driving shaft and the bearing assembly.

17. Printing module according to claim 16, wherein the bearing assembly comprises at least one pair of at least two bearing rollers positioned at mutual distance to receive at least a part of an outer circumferential surface of the rotary screen cylinder.

18. Printing module according to claim 16, wherein the central axes (h, H_{R}, H) of the driving shaft, the rotary screen cylinder and the impression cylinder, respectively, extend substantially in a same cylinder plane (V).

19. Printing module according to claim 16, wherein the driving shaft is movably connected with respect to a frame of the printing module.

20. Printing module according to claim 16, wherein the bearing assembly and/or the impression cylinder are movably connected with respect to the frame of the printing module.

21. Printing module according to claim 16, wherein the bearing assembly comprises a plurality of bearing rollers, arranged in pairs, wherein the respective bearing rollers of each pair are arranged at mutual distance, wherein the distance between the bearing rollers of the pair most remote from the impression cylinder is larger than the distance between the bearing rollers of the pair most near to the impression roller, wherein respective central axes of the bearing rollers of each pair extend in a plane that is arranged substantially perpendicular with respect to the cylinder plane (V).

22. Printing module according to claim 21, wherein the distance between the bearing rollers of each pair is adapted to receive a cooperating rotary screen cylinder with a cooperating diameter for printing an image with a certain repeat length such that said rotary screen cylinder is enclosed by the respective pair of bearing rollers and the driving shaft.

23. Printing module according to claim 17, wherein the or each pair of bearing rollers is located with respect to the impression cylinder such that an outer circumferential surface of the rotary screen cylinder in the bearing mounted position abuts against an outer circumferential surface of the impression cylinder.

24. Printing module according to claim 16, wherein the rotary screen cylinder comprises at least one transmission element, preferably arranged adjacent an end of the rotary screen cylinder.

25. Printing module according to claim 24, wherein the driving shaft comprises at least one transmission element, such as a gear wheel, that in use cooperates with the transmission element of the rotary screen cylinder to rotatably drive the rotary screen cylinder.

26. Printing module according to claim 16, wherein the driving shaft is removably received in a receiving section of a cylinder receiving unit provided in the printing module.

27. Printing module according to claim 16, wherein the cylinder receiving unit is adapted to receive a plate cylinder of another printing technology such as a flexographic plate cylinder or an offset plate cylinder.

28. Printing module according to claim 16, further comprising an ink system movably arranged with respect to a frame of the printing module.

29. Printing module according to claim 16, wherein the ink system is arranged at a side of the cylinder receiving unit facing away from the impression cylinder.

30. Printing apparatus comprising at least one printing module according to claim 16.

31. Printing module according to claim 17, wherein the central axes (h, H_{R}, H) of the driving shaft, the rotary screen cylinder and the impression cylinder, respectively, extend substantially in a same cylinder plane (V).

32. Printing module according to claim 17, wherein the driving shaft is movably connected with respect to a frame of the printing module.

33. Printing module according to claim 18, wherein the driving shaft is movably connected with respect to a frame of the printing module.

34. Printing module according to claim 17, wherein the bearing assembly and/or the impression cylinder are movably connected with respect to the frame of the printing module.

35. Printing module according to claim 18, wherein the bearing assembly and/or the impression cylinder are movably connected with respect to the frame of the printing module.
